(19) United States
(12) Patent Application Publication
(10) Pub. No.: US 2007/0055707 A1
(43) Pub. Date: Mar. 8, 2007

(54) Control of Policies for Setting File Associations When Configuring Information Handling Systems

(76) Inventors: Shree A. Dandekar, Round Rock, TX (US); Shannon Christopher Boesch, Austin, TX (US); James A. Howell JR., Georgetown, TX (US)

Correspondence Address: HAMILTON & TERRILE, LLP, P.O. BOX 203518, AUSTIN, TX, 78720, US

(21) Appl. No.: 11/554,125

(22) Filed: Oct. 30, 2006

Related U.S. Application Data
(63) Continuation-in-part of application No. 11/013,819, filed on Dec. 16, 2004.

(51) Int. Cl. G06F 17/30

(52) U.S. Cl. 707/200

(57) ABSTRACT

A file association recommendation function which when a user tries to execute a certain type of file such a multimedia file (e.g., a MP3 type file or JPG type file) for which there is no file association, a file association recommendation module is invoked that presents application recommendations to the user. The recommendation module will provide a user with a list of applications that may be associated with a particular type of file as well as a recommended application for the association. The recommendation module the queries the user to associate the MP3, JPG or multimedia content with one of the applications from the list of applications. The applications are pre-installed on the system. Based on the user's choice, the file association recommendation module sets that application as the default application for the certain type of file (e.g., Yahoo Music as default for playing MP3 for the user).

### RELATED PATENT APPLICATION

This application is a continuation-in-part of U.S. patent application Ser. No. 11/013,819, filed on Dec. 16, 2004 and entitled “Control of Policies for Setting Files Associations in Information Handling Systems,” and naming Shree A. Dandekar, Shannon Christopher Boesch and James A. Howell, Jr. as inventors.

### BACKGROUND OF THE INVENTION

1. Field of the Invention

The present invention relates to information handling systems and more particularly, to controlling policies for setting file associations within an information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to manufacture information handling systems based on a build to order process that allows a customer to specify specific hardware and software options. In general, known build to order systems require a large number of disjointed, manual processes that take place for a manufacturer to successfully validate and transform third-party vendor software packages to be factory installable. This not only increases the probability of human-induced error, but dramatically increases the time required to deliver validated, installable software images to the factory environment. It is desirable for an automated system for receiving software and for generating validated, factory-installable software without direct human interaction.

Often a manufacturer preloads the operating system as well as application programs onto information handling systems based upon a customer's order.

When application programs are loaded onto an information handling system, the application program often sets a file association. A file association establishes a relationship between a particular type of file and the application so that when the particular type of file is actuated, such as by double-clicking the particular type of file, the application that is associated with the particular type of file is automatically launched. In certain types of operating systems, such as the Microsoft Windows operating system, the particular type of file is identified by a file extension.

There are a plurality of issues relating setting a file association. More specifically, when there are multiple applications that use a similar type of file, it may be difficult to determine a preferred file association. Also, known factory install processes do not allow a manufacturer to customize file associations on the different applications based on the selection made by the customer at point-of-sale. For example, setting a music match application as a default MP3 player and setting a picture studio application as the default jpeg viewer. If a customer wishes to uninstall an application after receiving an ordered information handling system, it may be difficult to set the file associations to the next available manufacturer preferred application. Additionally, sometimes it is unclear to a user which file associations to select for particular types of files.

Accordingly, it would be desirable to provide a user with a file association recommendation when a file association is not present for a type of file.

### SUMMARY OF THE INVENTION

In accordance with the present invention, a process for controlling policies for setting file association defaults is set forth. The process provides a manufacturer with the flexibility of changing file associations and thus improves the customer experience.

The process enables setting file association policies and defaults during a factory installation process. More specifically, during a factory installation process, the process for controlling policies for setting file association defaults determines the applications to be installed on a particular information handling system. The process for controlling policies for setting file association defaults then sets all file association policies within a file association file such as an xml file. Next during the factory installation process, an installed application reads the file association file to determine the appropriate file association policy and claims the default file association to which the application has access.

The process also enables setting file association policies and defaults after an information handling system has been delivered to a customer. More specifically, the process for controlling policies for setting file association defaults creates a local file that automatically synchronizes with the web page. During a factory installation process, the process for controlling policies for setting file associations determines the applications to be installed onto the information handling system. The process for controlling policies for setting file association defaults then sets all file association policies within a file association file such as an xml file. Next, during the factory installation process, an installed application reads the file association file to determine the appropriate file association policy and claims the default file association to which the application has access. Also, during the factory installation process, a synchronization module is installed onto the information handling system. The synchronization module enables the information handling system to be synchronized with a suppler policy server after point-of-sale. The policy server provides updates to the information handling system. The updates may be based on, for example, contractual changes between the supplier and third party application vendors. The synchronization module executes and updates the file association file within the information handling system. The application having an updated file association then reads the file association file and reclaim or revoke file association policies accordingly.

The process also includes a file association recommendation function. With the file association recommendation function, every time a user tries to execute a certain type of file such a multimedia file (e.g., a MP3 type file or JPG type file) for which there is no file association, a file association recommendation module is invoked that presents application recommendations to the user. The recommendation module will provide a user with a list of applications that may be associated with a particular type of file as well as a recommended application for the association. The recommendation module the queries the user to associate the MP3, JPG or multimedia content with one of the applications from the list of applications. The applications are pre-installed on the system. Based on the user's choice, the file association recommendation module sets that application as the default application for the certain type of file (e.g., Yahoo Music as default for playing MP3 for the user).

The file association recommendation module provides a graphical user interface that facilitates the choice of the application the user wishes to use to play the multimedia content. The file association recommendation module provides an enhanced customer experience because the customer can select the applications the user wants to use after point of sale. The file association recommendation module may also include presenting options of programs for associating with the file that are not loaded onto the information handling system, and provide an opportunity for purchasing the software and services via the file association recommendation module.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an example of an automated build to order system for installing software on an information handling system.

FIG. 2 shows a system block diagram of an information handling system.

FIG. 3 shows a system for setting file association policies and defaults during a factory installation process.

FIG. 4 shows a system for setting file association policies and defaults during a factory installation process and after delivery of an information handling system.

FIG. 5 shows an overview block diagram representation of an on-line store.

FIG. 6 shows a system for providing file association recommendations after delivery of an information handling system.

### DETAILED DESCRIPTION

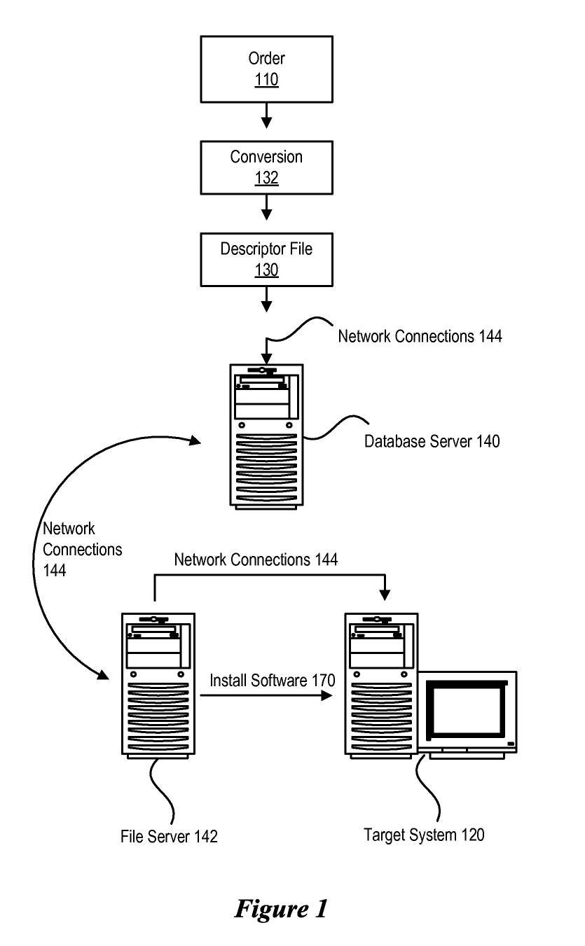

Referring to FIG. 1, a schematic diagram of a software installation system 100 at an information handling system manufacturing site is shown. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, and software. The software includes a particular version of an operating system along with all appropriate driver software and other application software along with appropriate software bug fixes. The software also includes middleware applications as appropriate for the operating system and application software.

Before the target information handling system 120 is shipped to the customer, the plurality of components are installed and tested from, for example, a fixed image of the software. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 1 10, which corresponds to a desired information handling system having desired components, into a computer readable format via conversion module 132. In one embodiment, the descriptor file 130 is a system descriptor record (SDR) file. The SDR file is a resource allocation file that includes text of which components are included within a particular information handling system.

Component descriptors are computer readable descriptions of the components of target information handling system 120 which components are defined by the order 110. In a preferred embodiment, the component descriptors are included in a descriptor file called a system descriptor record which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120. The software installation is controlled by a software installation management server that is operable to control the installation of the operating system and other software packages specified by a customer.

The software installation includes a process for controlling policies for setting file association defaults. The process provides a manufacturer with the flexibility of changing file associations and thus improves the customer experience.

The process enables setting file association policies and defaults during a factory installation process. More specifically, during a factory installation process, the process for controlling policies for setting file association defaults determines the applications to be installed on a particular information handling system. The process for controlling policies for setting file association defaults then sets all file association policies within a file association file such as an xml file. Next during the factory installation process, an installed application reads the file association file to determine the appropriate file association policy and claims the default file association to which the application has access.

The process also enables setting file association policies and defaults after an information handling system has been delivered to a customer. More specifically, the process for controlling policies for setting file association defaults creates a local file that automatically synchronizes with the web page. During a factory installation process, the process for controlling policies for setting file associations determines the applications to be installed onto the information handling system. The process for controlling policies for setting file association defaults then sets all file association policies within a file association file such as an xml file. Next, during the factory installation process, an installed application reads the file association file to determine the appropriate file association policy and claims the default file association to which the application has access. Also, during the factory installation process, a synchronization module is installed onto the information handling system. The synchronization module enables the information handling system to be synchronized with a suppler policy server after point-of-sale. The policy server provides updates to the information handling system. The updates may be based on, for example, contractual changes between the supplier and third party application vendors. The synchronization module executes and updates the file association file within the information handling system. The application having an updated file association then reads the file association file and reclaim or revoke file association policies accordingly.

Alternately, when enabling setting file association policies after an information handling system has been delivered to a customer, the process can provide a file association recommendation function. More specifically, with the file association recommendation function, every time a user tries to execute a certain type of file such a multimedia file (e.g., a MP3 type file or JPG type file) for which there is no file association, a file association recommendation module is invoked that presents application recommendations to the user. The recommendation module will provide a user with a list of applications that may be associated with a particular type of file as well as a recommended application for the association. The recommendation module the queries the user to associate the MP3, JPG or multimedia content with one of the applications from the list of applications. The applications are pre-installed on the system. Based on the user's choice, the file association recommendation module sets that application as the default application for the certain type of file (e.g., Yahoo Music as default for playing MP3 for the user).

The file association recommendation module provides a graphical user interface that facilitates the choice of the application the user wishes to use to play the multimedia content. The file association recommendation module provides an enhanced customer experience because the customer can now select the applications the user wants to use after point of sale. The file association recommendation module also includes presenting options of programs for associating with the file that are not loaded onto the information handling system, and provides an opportunity for purchasing the software and services via the file association recommendation module.

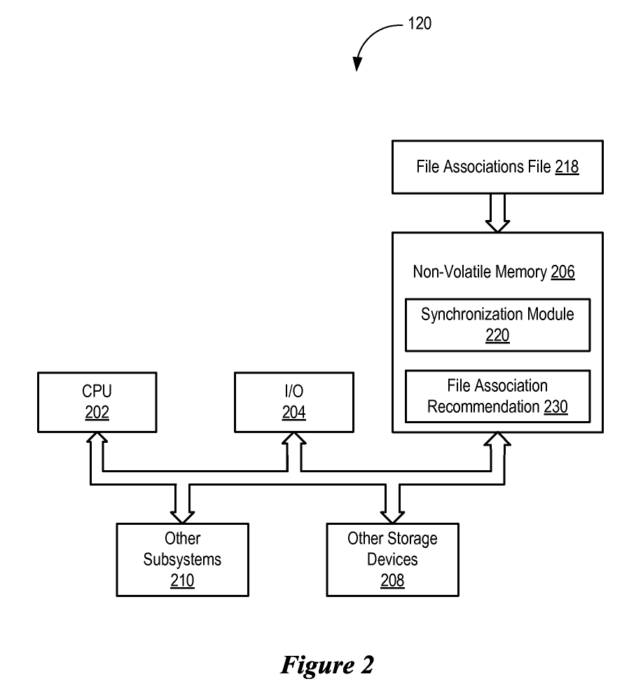

Referring to FIG. 2, a block diagram of an information handling system, such as the target information handling system 120 is shown. The information handling system includes a processor 202, input/output (I/O) devices 204, such as a display, a keyboard, a mouse, and associated controllers, non volatile memory 206 such as a hard disk drive, and other storage devices 208, such as a floppy disk and drive and other memory devices, and various other subsystems 210, all interconnected via one or more buses 212. The software is installed onto the non volatile memory 206. Alternately, the software may be installed onto any appropriate non-volatile memory. The non-volatile memory 206 may also store file associations file 218 and a synchronization module 220 for synchronizing file associations within the file associations file 218. The non-volatile memory 206 may also include a file association recommendation module 230 for providing file association recommendations.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

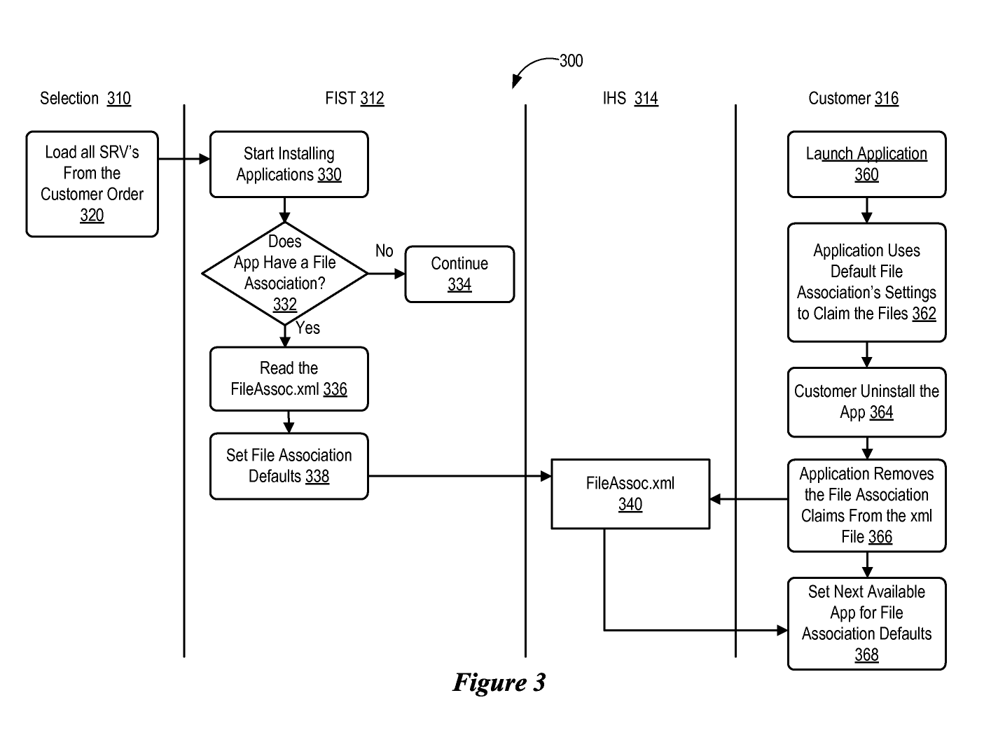

Referring to FIG. 3, a system 300 for setting file association policies and defaults during a factory installation process is shown. The system 300 includes a selection portion 310, a Factory Installation System Test (FIST) portion 312, an information handling system portion 314 and a customer portion 316. FIST is the process of starting the target information handling system, after software download, to install all drivers and applications.

When operating within the selection portion 310, the system 300 obtains particular components as identified by particular information part definitions for a particular information handling system at step 320 based upon a system descriptor record (SDR) for the particular information handling system. The components may be obtained from an appropriate software recovery vehicle (SRV).

Next, during the FIST portion 312, the factory install process starts by installing applications identified by the system descriptor record for the customer order at step 330. The system 300 then determines whether an installed application has a related file association at step 332. If not, then the factory installation process continues at step 334. (E.g., the factory installation process may install another program, may indicate that the installation process is complete, etc.) If the installed application does have a related file association, then the system 300 reads the file association file (e.g., a FileAssoc.xml file) at step 336 and sets the file association for the installed application as the file association default for the application at step 338.

Next, during the information handling system portion 314. the file association file is also stored on the information handling system with the default file associations at step 340.

Next, during the customer portion 316, when a customer launches an application at step 360, the application uses the default file association settings to claim associated files at step 362. (The file association would also be claimed if the customer actuated a file having the defined file association.) If the customer uninstalls the program at step 364, then the application removes the file association claims from the file association file at step 366 and accesses the file association file 340 to set a next available file association application from the file association defaults as set within the file association file at step 368.

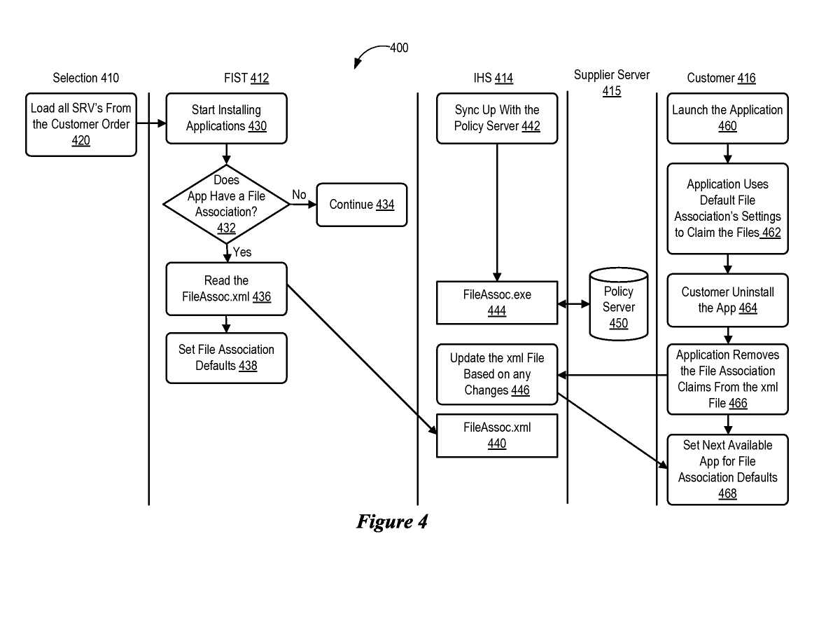

Referring to FIG. 4, a system 400 for setting file association policies and defaults during a factory installation process and an information handling system has been delivered to a customer is shown. The system 400 includes a selection portion 410, a Factory Installation System Test (FIST) portion 412, an information handling system portion 414, a supplier server portion 415 and a customer portion 416. FIST is the process of starting the target information handling system, after software download, to install all drivers and applications.

When operating within the selection portion 410, the system 400 obtains particular components as identified by particular information part definitions for a particular information handling system at step 420 based upon a system descriptor record (SDR) for the particular information handling system. The components may be obtained from an appropriate software recovery vehicle (SRV).

Next, during the FIST portion 412, the factory install process starts by installing applications identified by the system descriptor record for the customer order at step 430. The system 400 then determines whether an installed application has a related file association at step 432. If not, then the factory installation process continues at step 434. (E.g., the factory installation process may install another program, may indicate that the installation process is complete, etc.) If the installed application does have a related file association, then the system 400 reads the file association file (e.g., a FileAssoc.xml file) at step 436 and sets the file association for the installed application as the file association default for the application at step 438.

Next, during the information handling system portion 414. the file association file is also stored on the information handling system with the default file associations at step 440. Additionally, the information handing system synchronizes with a file association policy server at step 442 by executing a file association synchronization module (e.g., FileAssoc.exe) at step 444. The file association synchronization module updates the file association file based upon changes indicated within the supplier server portion 446 and specifically stored within a policy server 450.

Next, during the customer portion 416, when a customer launches an application at step 460, the application uses the default file association settings to claim associated files at step 462. (The file association would also be claimed if the customer actuated a file having the defined file association.) If the customer uninstalls the program at step 464, then the application removes the file association claims from the file association file at step 466 and accesses the file association file 440 to set a next available file association application from the file association defaults as set within the file association file at step 468. Because the file association file is updated via the policy server 450, any manufacturer updates to the file associations are propagated to the customer information handling system.

An online store is one component of an Internet website to which a customer may go to configure a particular information handling system, for example, according to desired options of the customer. The online store is typically a subset of a larger Internet website. At the online store, a customer can select one or more products in which the customer is interested. Upon selection of a particular product, the online store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the online store application controls.

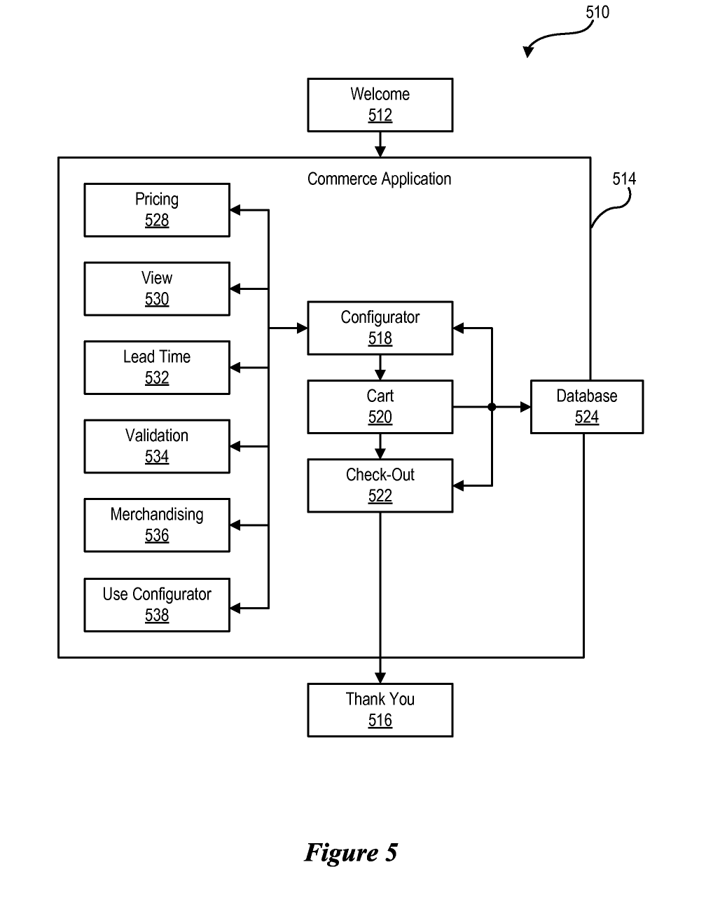

Referring now to FIG. 5, an online store 510 for use in generating customer configured information handling systems, e.g., customer configured computer systems, is shown. The online store 510 includes a welcome or introductory module 552, a commerce application module 514, and a thank you module 516. The online store 510 includes an online store user interface which enables the system configuration, pricing, and ordering of an information handling system via the Internet. The commerce application 514 includes a configurator 518, shopping cart 520, a checkout module 522, a services activation module 523 and database 524. The database 524 provides information to the configurator 518, shopping cart 520, checkout module 522. The configurator 518 includes a pricing module 528, a view module 530, a lead time warning module 532, a validation (or compatibility) warning module 534, a merchandising module 536 and a use configuration module 538. The various modules of the configurator 518 are driven by data from the database 524, and thus the configurator 518, shopping cart 520, and checkout module 522 are all linked to the database 524.

In operation of the online store 510, the welcome module 552 presents a welcome page 552, the configurator 518 presents a configurator page, the shopping cart 520 presents a shopping cart page, the checkout module 522 presents a checkout page, and the thank you module 516 presents a thank you page. The welcome page includes a static page and generally resides outside of the commerce application 514. The configurator page, shopping cart page, and checkout page are within the commerce application and use information provided by the database. The checkout includes a payment feature, delivery feature, personal verses business feature, and instructional text features (i.e., how to fill out an online form.)

The welcome page is typically an introductory page and includes a link into the online store 5 10. The welcome page is typically a static welcome page. Upon completion of configuration of a system, the customer is transferred to a checkout page. After completion of the checkout, the customer is transferred to a static thank you page 516. The thank you page 516 provides a message of gratitude to the customer for having placed the order or for visiting the online store.

Aspects of the configurator 518 which interact with database 524 are shown in FIG. 5. In essence, the entire commerce application 514 interacts with the database. The configurator 518, shopping cart 520, and checkout module 522 are each part of the commerce application 514 and interact with the database 524. For example, with the shopping cart 520, additional merchandising information associated with a particular system which has been configured and placed in the shopping cart by an online store customer can be provided.

The use configuration module 538 provides the configurator 518 with the ability to present to a user a configurator which presents a customer with information regarding desirable configuration bundles that are based upon a specific intended use and to enable a customer to configure a system based upon the specific intended use. The use configuration module 538 interacts with the database 524 to obtain information regarding specific intended uses and present this information to the customer.

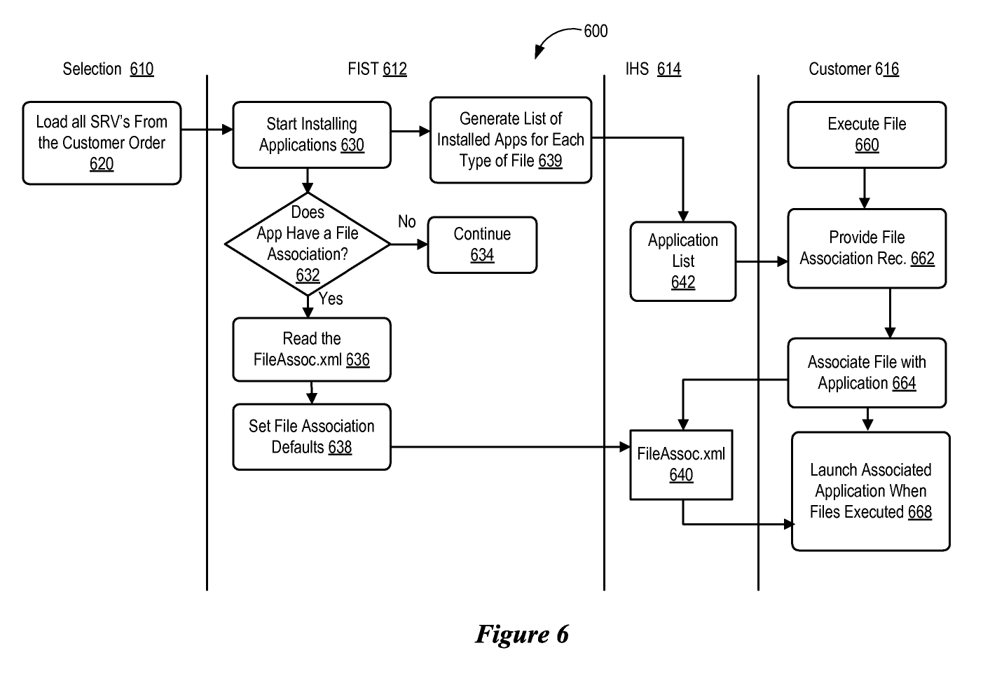

Referring to FIG. 6, a system for providing file association recommendations after delivery of an information handling system is shown.

The system 600 includes a selection portion 610, a Factory Installation System Test (FIST) portion 612, an information handling system portion 614 and a customer portion 616. FIST is the process of starting the target information handling system, after software download, to install all drivers and applications.

When operating within the selection portion 610, the system 600 obtains particular components as identified by particular information part definitions for a particular information handling system at step 620 based upon a system descriptor record (SDR) for the particular information handling system. The components may be obtained from an appropriate software recovery vehicle (SRV).

Next, during the FIST portion 612, the factory install process starts by installing applications identified by the system descriptor record for the customer order at step 630. The system 600 then determines whether an installed application has a related file association at step 632. If not, then the factory installation process continues at step 634. (E.g., the factory installation process may install another program, may indicate that the installation process is complete, etc.) If the installed application does have a related file association, then the system 600 reads the file association file (e.g., a FileAssoc.xml file) at step 636 and sets the file association for the installed application as the file association default for the application at step 638.

Additionally, during the factory install process, a list of installed applications that correspond to a particular file type is generated at step 639. The list may include a listing of installed applications for each type of file that may have an associated application.

Next, during the information handling system portion 614, the file association file is stored on the information handling system with the default file associations at step 640. Additionally, the list of applications is stored on the information handling system at step 642

Next, during the customer portion 616, when a user executes a file (e.g., by actuating an icon representation of the file) for which a file association is not present at step 660, the file association recommendation module 230 executes and provides a file association recommendation at step 662. When an association is selected by the customer, the file association recommendation module associates the file type with the selected application at step 664 and stores this association in the file association file 640. Next the file association recommendation module launches the application that was associated with the file at step 668 when files corresponding to the file type are executed.

Other embodiments are within the following claims.

For example, while specific applications and file associations are identified, other applications and file associations are also contemplated.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for setting file associations comprising:
determining applications capable of executing a particular file type and are installed onto an information handling system;
providing a file association recommendation based upon the applications that are capable of executing a particular file type and are installed on the information handling system;
enabling selection one of the applications capable of executing a particular file type to be associated with the particular file type;
setting a file association that sets file association policies within a file association file based upon the selection;
accessing the file association file to determine an appropriate file association; and,
associating files with the application based upon the file association policies.

2. The method of claim 1, wherein
the file association file includes an extensible markup language (XML) file.

3. The method of claim 1, further comprising:
presenting a user with additional applications that are capable of executing the particular file type.

4. The method of claim 3, further comprising:
enabling a user to purchase at least one of the additional applications that are capable of executing the particular file type.

5. The method of claim 1, further comprising
installing a plurality of applications onto the information handling system;
determining which of the plurality of applications can be associated with a particular file type; and,
generating a list of the applications that can be associated with the particular file type.

6. An apparatus for setting file associations comprising:
means for determining applications capable of executing a particular file type and are installed onto an information handling system;
means for providing a file association recommendation based upon the applications that are capable of executing a particular file type and are installed on the information handling system;
means for enabling selection one of the applications capable of executing a particular file type to be associated with the particular file type;
means for setting a file association that sets file association policies within a file association file based upon the selection;
means for accessing the file association file to determine an appropriate file association; and,
means for associating files with the application based upon the file association policies.

7. The apparatus of claim 6, wherein
the file association file includes an extensible markup language (XML) file.

8. The apparatus of claim 6, further comprising:
means for presenting a user with additional applications that are capable of executing the particular file type.

9. The apparatus of claim 8, further comprising:
means for enabling a user to purchase at least one of the additional applications that are capable of executing the particular file type.

10. The apparatus of claim 6, wherein
a plurality of applications are installed on the information handling system; and further comprising
means for determining which of the plurality of applications can be associated with a particular file type; and,
means for generating a list of the applications that can be associated with the particular file type.

11. An information handling system comprising:
a processor;
a memory coupled to the processor, the memory storing a file association recommendation module, the file association recommendation module comprising instruction for
determining applications capable of executing a particular file type and are installed onto an information handling system;
providing a file association recommendation based upon the applications that are capable of executing a particular file type and are installed on the information handling system;
enabling selection one of the applications capable of executing a particular file type to be associated with the particular file type;
setting a file association that sets file association policies within a file association file based upon the selection;
accessing the file association file to determine an appropriate file association; and,
associating files with the application based upon the file association policies.

12. The information handling system of claim 11, wherein
the file association file includes an extensible markup language (XML) file.

13. The information handling system of claim 11, wherein the file association recommendation module further comprises instructions for:
presenting a user with additional applications that are capable of executing the particular file type.

14. The information handling system of claim 13, wherein the file association recommendation module further comprises instructions for:
enabling a user to purchase at least one of the additional applications that are capable of executing the particular file type.

15. The information handling system of claim 11, wherein
a plurality of applications are installed on the information handling system;
and the file association recommendation module further comprises instructions for:
determining which of the plurality of applications can be associated with a particular file type; and,
generating a list of the applications that can be associated with the particular file type.
